(19) United States
(12) Patent Application Publication
(10) Pub. No.: US 2021/0023956 A1
(43) Pub. Date: Jan. 28, 2021

(54) DATA UPLOADING AT CHARGING STATION

(71) Applicant: TOYOTA MOTOR ENGINEERING & MANUFACTURING NORTH AMERICA, INC., Erlanger, KY (US)

(72) Inventor: Prashant TIWARI, Mountain View, CA (US)

(21) Appl. No.: 16/521,567

(22) Filed: Jul. 24, 2019

(51) Int. Cl. B60L 53/66; G07C 5/00; G07C 5/08; B60L 53/65; G05D 1/00

(52) U.S. Cl. CPC B60L 53/66; G07C 5/008; G05D 2201/0213; B60L 53/65; G05D 1/0088; G07C 5/0808

(57) ABSTRACT

The disclosure includes embodiments for uploading vehicle data at a charging station. In some embodiments, a method includes determining that a threshold proximity is satisfied. The threshold proximity describes a range between a connected vehicle and the charging station for charging the connected vehicle. The method further includes wirelessly transmitting vehicle data to the charging station. The wireless transmission of the vehicle data occurs responsive to the determination that the threshold proximity is satisfied.

### BACKGROUND

The specification relates to uploading vehicle data at a charging station.

A modern vehicle may have various sensors installed therein and may sense its internal and external environment using these sensors. For example, a vehicle may detect its surroundings using various sensors (e.g., radar, LIDAR, camera, etc.) and generate various sensor data. The vehicle may upload the sensor data to a centralized location (e.g., a server) for further analysis. In some scenarios, it may be inconvenient or infeasible for the vehicle to upload the sensor data to the centralized location directly. For example, it may be expensive to upload the sensor data from the vehicle to the centralized location directly using cellular transmission. In another example, a direct data transmission from the vehicle to the centralized location is not possible because the vehicle does not have network access at some locations.

### SUMMARY

One general aspect of embodiments described herein includes a computer program product including a non-transitory memory of an onboard vehicle computer system of a connected vehicle storing computer-executable code that, when executed by a processor, causes the processor to: collect vehicle data associated with the connected vehicle; determine that a threshold proximity is satisfied, where the threshold proximity describes a range between the connected vehicle and a charging station for charging the connected vehicle; and wirelessly transmit the vehicle data to the charging station, where the wireless transmission of the vehicle data occurs responsive to the determination that the threshold proximity is satisfied. Other embodiments of this aspect include corresponding computer systems, apparatus, and computer programs recorded on one or more computer storage devices, each configured to perform the actions of the methods.

Implementations may include one or more of the following features. The computer program product where the charging station is operable to relay the vehicle data to a centralized location. The computer program product where the vehicle data is analyzable to determine whether a black-market part is installed in the connected vehicle. The computer program product where the vehicle data describes one or more of the following: diagnostic information about the connected vehicle; performance information about the connected vehicle; and efficiency information about the connected vehicle. Implementations of the described techniques may include hardware, a method or process, or computer software on a computer-accessible medium.

One general aspect includes a method, including: determining that a threshold proximity is satisfied, where the threshold proximity describes a range between a connected vehicle and a charging station for charging the connected vehicle; and wirelessly transmitting vehicle data to the charging station, where the wireless transmission of the vehicle data occurs responsive to the determination that the threshold proximity is satisfied. Other embodiments of this aspect include corresponding computer systems, apparatus, and computer programs recorded on one or more computer storage devices, each configured to perform the actions of the methods.

Implementations may include one or more of the following features. The method where the charging station is operable to relay the vehicle data to a centralized location. The method where the vehicle data is analyzable to determine whether a black-market part is installed in the connected vehicle. The method where the vehicle data describes one or more of the following: diagnostic information about the connected vehicle; performance information about the connected vehicle; and efficiency information about the connected vehicle. The method where the connected vehicle is an autonomous vehicle. The method where the wireless transmission is unicast. The method where the wireless transmission is broadcast. The method where the charging station includes an edge server. Implementations of the described techniques may include hardware, a method or process, or computer software on a computer-accessible medium.

One general aspect includes a system including a computer system including a non-transitory memory storing computer code which, when executed by the computer system, causes the computer system to: determine that a threshold proximity is satisfied, where the threshold proximity describes a range between a connected vehicle and a charging station for charging the connected vehicle; and wirelessly transmit vehicle data to the charging station, where the wireless transmission of the vehicle data occurs responsive to the determination that the threshold proximity is satisfied. Other embodiments of this aspect include corresponding computer systems, apparatus, and computer programs recorded on one or more computer storage devices, each configured to perform the actions of the methods.

Implementations may include one or more of the following features. The system where the charging station is operable to relay the vehicle data to a centralized location. The system where the vehicle data is analyzable to determine whether a black-market part is installed in the connected vehicle. The system where the vehicle data describes one or more of the following: diagnostic information about the connected vehicle; performance information about the connected vehicle; and efficiency information about the connected vehicle. The system where the connected vehicle is an autonomous vehicle. The system where the wireless transmission is unicast. The system where the wireless transmission is broadcast. The system where the charging station includes an edge server. Implementations of the described techniques may include hardware, a method or process, or computer software on a computer-accessible medium.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an operating environment for a data uploading system according to some embodiments.

FIG. 2 is a block diagram illustrating an example computer system including the data uploading system according to some embodiments.

FIG. 3 depicts a method for uploading vehicle data at a charging station according to some embodiments.

### DETAILED DESCRIPTION

It may be desirable to upload data collected by a vehicle to a centralized location so that the collected data can be processed at the centralized location to provide analysis related to a behavior or an operating performance of the vehicle. In some cases, an intermediate node may be needed to receive the data from the vehicle and then relay the data to the centralized location.

Described herein are embodiments of a data uploading system that is installed in the vehicle and automatically transfers vehicle data from the vehicle to the centralized location via a charging station when the vehicle comes within a proximity of the charging station. The charging station may include an edge server which handles communication functionality for the charging station. In some embodiments, any type of trusted device having network communication capabilities may be substituted for the charging station.

Example improvements and advantages provided by the data uploading system described herein are provided here. For example, the data uploading system installed in the vehicle automatically uploads vehicle data collected by the vehicle to the charging station so that the charging station can forward the vehicle data to a centralized location for further processing. In this case, potential charges caused by cellular transmission between the vehicle and the centralized location can be reduced or avoided. In another example, for an electric vehicle or a hybrid vehicle, the data uploading system installed in the vehicle can upload the vehicle data to the charging station while the vehicle is being charged at the charging station. In this case, the data uploading task and the charging task can be executed simultaneously to save time. Other example advantages are also possible.

### Example Overview

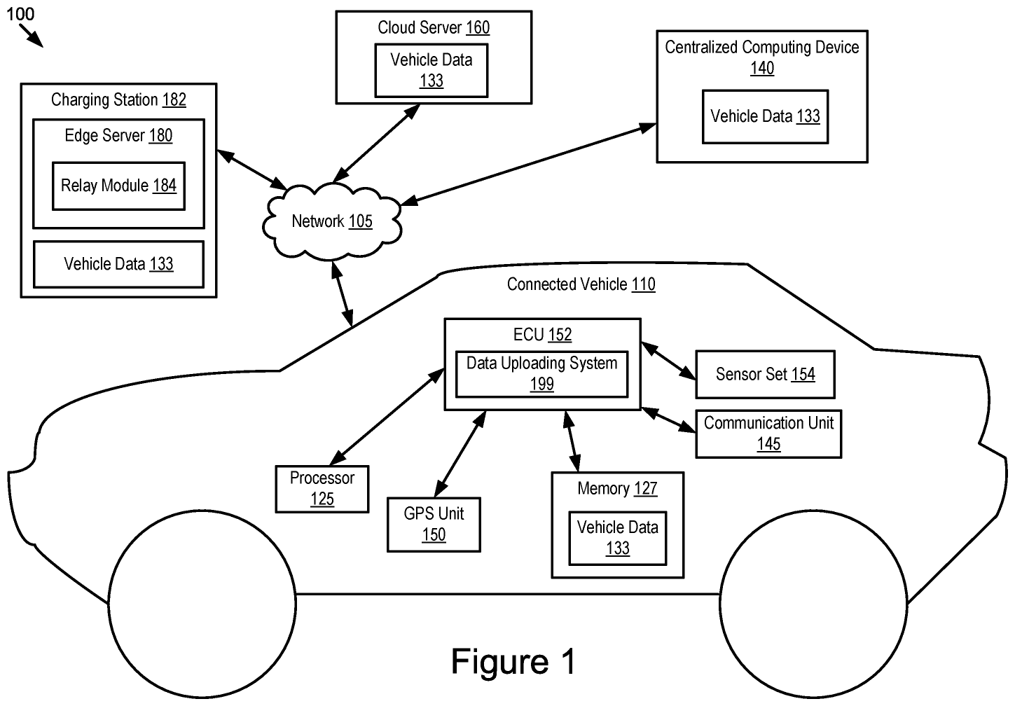

Referring to FIG. 1, depicted is an operating environment 100 for a data uploading system 199 according to some embodiments. The operating environment 100 may include one or more of the following elements: a connected vehicle 110; a centralized computing device 140; a cloud server 160; and a charging station 182. These elements of the operating environment 100 may be communicatively coupled to a network 105. In practice, the operating environment 100 may include any number of connected vehicles 110, centralized computing devices 140, cloud servers 160, charging stations 182 and networks 105.

The network 105 may be a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices and/or entities may communicate. In some embodiments, the network 105 may include a peer-to-peer network. The network 105 may also be coupled to or may include portions of a telecommunications network for sending data in a variety of different communication protocols. In some embodiments, the network 105 includes Bluetooth® communication networks or a cellular communications network for sending and receiving data including via short messaging service (SMS) and multimedia messaging service (MMS). In some embodiments, the network 105 further includes networks for hypertext transfer protocol (HTTP), direct data connection, wireless application protocol (WAP), e-mail, Dedicated Short Range Communication (DSRC), full-duplex wireless communication and mmWave. In some embodiments, the network 105 further includes networks for WiFi (infrastructure mode), WiFi (ad-hoc mode), visible light communication, TV white space communication and satellite communication. The network 105 may also include a mobile data network that may include 3G, 4G, Long Term Evolution (LTE), LTE-Vehicle-to-Everything (LTE-V2X), LTE-Device-to-Device (LTE-D2D), Voice over LTE (VoLTE), 5G-V2X or any other mobile data network. The network 105 may also include any combination of mobile data networks. Further, the network 105 may include one or more IEEE 802.11 wireless networks.

The connected vehicle 110 may be any type of vehicle. For example, the connected vehicle 110 may include one of the following types of vehicles: a car; a truck; a sports utility vehicle; a bus; a semi-truck; a drone; or any other roadway-based conveyance. The connected vehicle 110 may include a communication unit and is capable of communicating with other endpoints connected to the network 105. The connected vehicle 110 may be an electric vehicle or a hybrid vehicle.

In some embodiments, the connected vehicle 110 is a DSRC-enabled vehicle which includes a DSRC radio and a DSRC-compliant Global Positioning System (GPS) unit. The connected vehicle 110 may also include other V2X radios besides a DSRC radio. DSRC is not a requirement of embodiments described herein, and any form of V2X communications is also feasible. Further examples of V2X communications include the following: LTE; millimeter wave (mmWave) communication; 3G; 4G; 5G; LTE-V2X; 5G-V2X; LTE-Vehicle-to-Vehicle (LTE-V2V); LTE-D2D; or VoLTE; etc. In some examples, the V2X communications can include V2V communications, Vehicle-to-Infrastructure (V2I) communications, Vehicle-to-Network (V2N) communications or any combination thereof.

The connected vehicle 110 may include one or more of the following elements: a processor 125; a memory 127; a communication unit 145; a GPS unit 150; an electronic control unit (ECU) 152; a sensor set 154; and a data uploading system 199. These elements of the connected vehicle 110 may be communicatively coupled to one another via a bus.

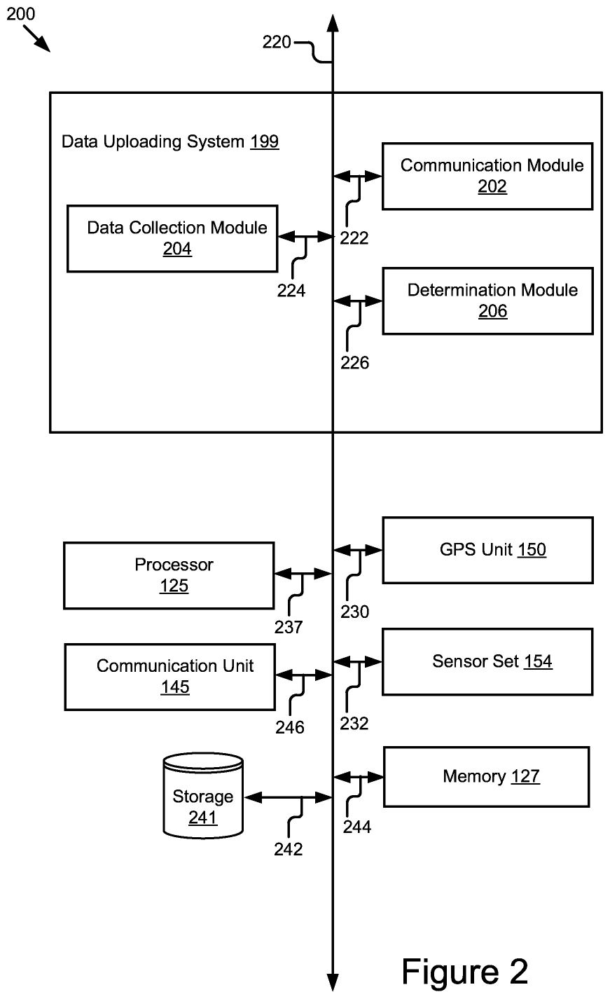

In some embodiments, the processor 125 and the memory 127 may be elements of an onboard vehicle computer system (such as computer system 200 described below with reference to FIG. 2). The onboard vehicle computer system may be operable to cause or control the operation of the data uploading system 199. For example, the onboard vehicle computer system may be operable to access and execute the data stored on the memory 127 to provide the functionality described herein for the data uploading system 199 or its elements (see, e.g., FIG. 2).

The processor 125 includes an arithmetic logic unit, a microprocessor, a general-purpose controller, or some other processor array to perform computations and provide electronic display signals to a display device. The processor 125 processes data signals and may include various computing architectures. Example computing architectures include a complex instruction set computer (CISC) architecture, a reduced instruction set computer (RISC) architecture, or an architecture implementing a combination of instruction sets. The connected vehicle 110 may include one or more processors 125. Other processors, operating systems, sensors, displays, and physical configurations may be possible.

The memory 127 stores instructions or data that may be executed by the processor 125. The instructions or data may include code for performing the techniques described herein. The memory 127 may be a dynamic random-access memory (DRAM) device, a static random-access memory (SRAM) device, flash memory, or some other memory device. In some embodiments, the memory 127 also includes a non-volatile memory or similar permanent storage device and media. Example permanent storage devices include a hard disk drive, a floppy disk drive, a CD-ROM device, a DVD-ROM device, a DVD-RAM device, a DVD-RW device, and a flash memory device, etc. Additional example permanent storage devices may include some other mass storage device for storing information on a more permanent basis. The connected vehicle 110 may include one or more memories 127.

The memory 127 may store vehicle data 133. In some embodiments, the vehicle data 133 may include sensor data of the connected vehicle 110. The sensor data may include digital data describing one or more sensor measurements recorded by the connected vehicle 110. For example, the vehicle data 133 includes one or more of the following: diagnostic information of the vehicle 110; and vehicle performance and efficiency information of the vehicle 110. In another example, the vehicle data 133 may also include one or more of the following: information pertaining to “black market” parts placed on the vehicle 110 (if there is any); and digital data indicating whether the vehicle 110 has been reported stolen, etc. The vehicle data 133 may also include any other information related to the connected vehicle 110.

The communication unit 145 transmits and receives data to and from the network 105 or to another communication channel. In some embodiments, the communication unit 145 may include a DSRC transceiver, a DSRC receiver and other hardware or software necessary to make the connected vehicle 110 a DSRC-enabled device. For example, the communication unit 145 includes a DSRC antenna configured to broadcast DSRC messages via the network. The DSRC antenna may also transmit BSM messages at a fixed or variable interval (e.g., every 0.1 seconds, at a time interval corresponding to a frequency range from 1.6 Hz to 10 Hz, etc.) that is user configurable.

In some embodiments, the communication unit 145 includes a port for direct physical connection to the network 105 or to another communication channel. For example, the communication unit 145 includes a USB, SD, CAT-5, or similar port for wired communication with the network 105. In some embodiments, the communication unit 145 includes a wireless transceiver for exchanging data with the network 105 or other communication channels using one or more wireless communication methods. Example wireless communication methods may include one or more of the following: IEEE 802.11; and IEEE 802.16, BLUETOOTH®. Example wireless communication methods may further include EN ISO 14906:2004 Electronic Fee Collection—Application interface EN 11253:2004 DSRC—Physical layer using microwave at 5.8 GHz (review). Example wireless communication methods may further include EN 12795:2002 DSRC—DSRC Data link layer: Medium Access and Logical Link Control (review). Example wireless communication methods may further include EN 12834:2002 DSRC—Application layer (review) and EN 13372:2004 DSRC—DSRC profiles for RTTT applications (review). Example wireless communication methods may further include the communication method described in U.S. patent application Ser. No. 14/471,387 filed on Aug. 28, 2014 and entitled “Full-Duplex Coordination System”; or another suitable wireless communication method.

In some embodiments, the communication unit 145 includes a cellular communications transceiver for sending and receiving data over a cellular communications network. For example, the data may be sent or received via short messaging service (SMS), multimedia messaging service (MMS), hypertext transfer protocol (HTTP), direct data connection, WAP, e-mail, or another suitable type of electronic communication. In some embodiments, the communication unit 145 includes a wired port and a wireless transceiver. The communication unit 145 also provides other conventional connections to the network 105 for distribution of files or media objects using standard network protocols including TCP/IP, HTTP, HTTPS, and SMTP, millimeter wave, DSRC, etc.

The communication unit 145 may include a V2X radio. The V2X radio may include a hardware element including a DSRC transmitter which is operable to transmit DSRC messages on the 5.9 GHz band. The 5.9 GHz band is reserved for DSRC messages. The hardware element may also include a DSRC receiver which is operable to receive DSRC messages on the 5.9 GHz band.

In some embodiments, the GPS unit 150 is a conventional GPS unit of the connected vehicle 110. For example, the GPS unit 150 may include hardware that wirelessly communicates with a GPS satellite to retrieve data that describes a geographic location of the connected vehicle 110. In some embodiments, the GPS unit 150 is a DSRC-compliant GPS unit of the connected vehicle 110. The DSRC-compliant GPS unit is operable to provide GPS data describing the geographic location of the connected vehicle 110 with lane-level accuracy.

The ECU 152 can include one or more processors and one or more memories. The ECU 152 may control an operation of the sensor set 154 and the data uploading system 199 of the connected vehicle 110. In some embodiments, the data uploading system 199 is installed in the ECU 152.

The sensor set 154 includes one or more sensors that are operable to measure a roadway environment outside of the connected vehicle 110. For example, the sensor set 154 may include one or more sensors that record one or more physical characteristics of the roadway environment that is proximate to the connected vehicle 110. The memory 127 may store sensor data that describes the one or more physical characteristics recorded by the sensor set 154.

The sensor set 154 may also include various sensors that record an environment internal to a cabin of the connected vehicle 110. For example, the sensor set 154 includes onboard sensors which monitor the environment of the connected vehicle 110 whether internally or externally. In a further example, the sensor set 154 includes cameras, LIDAR, radars, infrared sensors, and sensors that observe the behavior of the driver such as internal cameras, biometric sensors, etc.

In some embodiments, the sensor set 154 may include one or more of the following vehicle sensors: a camera; a LIDAR sensor; a radar sensor; a laser altimeter; an infrared detector; a motion detector; a thermostat; and a sound detector. The sensor set 154 may also include one or more of the following sensors: a carbon monoxide sensor; a carbon dioxide sensor; an oxygen sensor; a mass air flow sensor; and an engine coolant temperature sensor. The sensor set 154 may also include one or more of the following sensors: a throttle position sensor; a crank shaft position sensor; an automobile engine sensor; a valve timer; an air-fuel ratio meter; and a blind spot meter. The sensor set 154 may also include one or more of the following sensors: a curb feeler; a defect detector; a Hall effect sensor, a manifold absolute pressure sensor; a parking sensor; a radar gun; a speedometer; and a speed sensor. The sensor set 154 may also include one or more of the following sensors: a tire-pressure monitoring sensor; a torque sensor; a transmission fluid temperature sensor; and a turbine speed sensor (TSS); a variable reluctance sensor; and a vehicle speed sensor (VSS). The sensor set 154 may also include one or more of the following sensors: a water sensor; a wheel speed sensor; and any other type of automotive sensor.

In some embodiments, the data uploading system 199 includes software that is operable to upload vehicle data from the connected vehicle 110 to the charging station 182. In some embodiments, the data uploading system 199 may be implemented using hardware including a field-programmable gate array (“FPGA”) or an application-specific integrated circuit (“ASIC”). In some other embodiments, the data uploading system 199 may be implemented using a combination of hardware and software. The data uploading system 199 may be stored in a combination of the devices (e.g., servers or other devices), or in one of the devices.

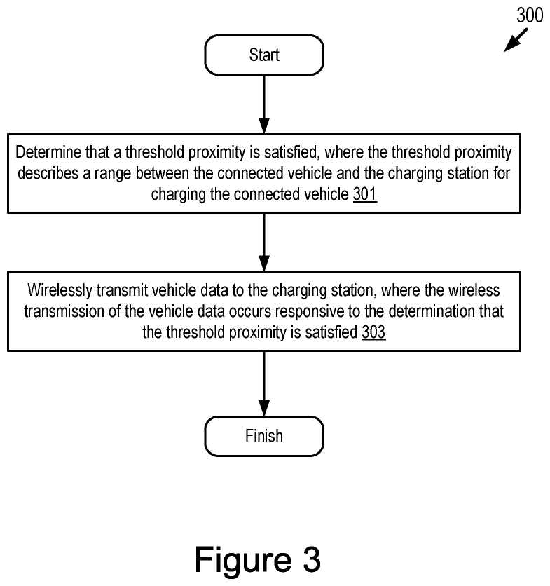

The data uploading system 199 is described below in more detail with reference to FIGS. 2-3.

The charging station 182 can be any charging station at a roadside, a parking lot, a garage, a third-party repair shop, a dealership, or any other appropriate place. In some embodiments, the charging station 182 includes one or more of the following elements: an edge server 180; and a memory that stores the vehicle data 133 received from the connected vehicle 110.

The edge server 180 may handle communication functionality for the charging station 182. In some embodiments, the edge server 180 may include a communication unit that is similar to the communication unit 145. The edge server 180 may handle communications between the charging station 182 and the connected vehicle 110 to receive the vehicle data 133 from the connected vehicle 110. The edge server 180 may also handle communications between the charging station 182 and the centralized computing device 140 (or the cloud server 160) to relay the vehicle data 133 to the centralized computing device 140 (or the cloud server 160). For example, the edge server 180 may include a relay module 184 that is operable to receive the vehicle data 133 from the connected vehicle 110 and relay the vehicle data 133 to the centralized computing device 140 (or the cloud server 160) for subsequent processing.

The centralized computing device 140 may be a computing device at a centralized location. In some embodiments, the centralized computing device 140 may include a memory that stores the vehicle data 133 received from the charging station 182 for further processing and analysis.

The cloud server 160 may be any cloud computing device that includes one or more processors and one or more memories. The cloud server 160 may also include a memory that stores the vehicle data 133 received from the charging station 182 for further processing and analysis.

A specific example that illustrates a cooperation process between the charging station 182 and the data uploading system 199 installed in the connected vehicle 110 is provided here. In this example, the charging station 182 is installed at a dealership. The connected vehicle 110 comes within a predetermined proximity of the charging station 182 (e.g., a distance between the connected vehicle 110 and the charging station 182 is smaller than a distance threshold such as 0.5 m, 1 m, 2 m, etc.). The data uploading system 199 determines that the connected vehicle 110 is within the predetermined proximity. The data uploading system 199 causes the vehicle data 133 to be wirelessly transmitted from the connected vehicle 110 to the charging station 182 because the connected vehicle 110 is within the predetermined proximity. The relay module 184 at the charging station 182 receives the vehicle data 133 from the data uploading system 199 and uploads the vehicle data 133 to the cloud server 160 or the centralized computing device 140 for subsequent processing or analysis.

### Example Computer System

Referring now to FIG. 2, depicted is a block diagram illustrating an example computer system 200 including the data uploading system 199 according to some embodiments. In some embodiments, the computer system 200 may include a special-purpose computer system that is programmed to perform one or more steps of a method 300 described below with reference to FIG. 3.

In some embodiments, the computer system 200 may be an element of the connected vehicle 110. In some embodiments, the computer system 200 may be an onboard vehicle computer of the connected vehicle 110. In some embodiments, the computer system 200 may include an engine control unit, head unit or some other processor-based computing device of the connected vehicle 110.

The computer system 200 may include one or more of the following elements according to some examples: the data uploading system 199; the processor 125; and the communication unit 145. The computer system 200 may further include one or more of the following elements: the sensor set 154; the GPS unit 150; the memory 127; and a storage 241. The components of the computer system 200 are communicatively coupled by a bus 220.

In the illustrated embodiment, the processor 125 is communicatively coupled to the bus 220 via a signal line 237. The communication unit 145 is communicatively coupled to the bus 220 via a signal line 246. The storage 241 is communicatively coupled to the bus 220 via a signal line 242. The GPS unit 150 is communicatively coupled to the bus 220 via a signal line 230. The sensor set 154 is communicatively coupled to the bus 220 via a signal line 232. The memory 127 is communicatively coupled to the bus 220 via a signal line 244.

The following elements are described above with reference to FIG. 1: the processor 125; the communication unit 145; the sensor set 154; the GPS unit 150; and the memory 127. Those descriptions will not be repeated here.

The storage 241 can be a non-transitory storage medium that stores data for providing the functionality described herein. The storage 241 may be a DRAM device, a SRAM device, flash memory, or some other memory devices. In some embodiments, the storage 241 also includes a non-volatile memory or similar permanent storage device and media (e.g., a hard disk drive, a floppy disk drive, a flash memory device, etc.) for storing information on a more permanent basis.

In the illustrated embodiment shown in FIG. 2, the data uploading system 199 includes: a communication module 202; a data collection module 204; and a determination module 206. These components of the data uploading system 199 are communicatively coupled to each other via the bus 220. In some embodiments, components of the data uploading system 199 can be stored in a single server or device. In some other embodiments, components of the data uploading system 199 can be distributed and stored across multiple servers or devices.

The communication module 202 can be software including routines for handling communications between the data uploading system 199 and other components of the computer system 200. In some embodiments, the communication module 202 can be stored in the memory 127 of the computer system 200 and can be accessible and executable by the processor 125. The communication module 202 may be adapted for cooperation and communication with the processor 125 and other components of the computer system 200 via a signal line 222.

The communication module 202 sends and receives data, via the communication unit 145, to and from one or more elements of the operating environment 100. For example, the communication module 202 transmits, via the communication unit 145, vehicle data of the connected vehicle 110. The communication module 202 may send or receive any of the data or messages described above with reference to FIG. 1 via the communication unit 145.

In some embodiments, the communication module 202 receives data from the other components of the data uploading system 199 and stores the data in one or more of the storage 241 and the memory 127. The other components of the data uploading system 199 may cause the communication module 202 to communicate with the other elements of the computer system 200 or the operating environment 100 (via the communication unit 145). For example, the data collection module 204 may use the communication module 202 to communicate with the sensor set 154 and cause the sensor set 154 to record sensor data.

The data collection module 204 can be software including routines for collecting vehicle data of the connected vehicle 110. In some embodiments, the data collection module 204 can be stored in the memory 127 of the computer system 200 and can be accessible and executable by the processor 125. The data collection module 204 may be adapted for cooperation and communication with the processor 125 and other components of the computer system 200 via a signal line 224.

In some embodiments, the data collection module 204 receives sensor data from one or more sensors of the connected vehicle 110. For example, the data collection module 204 is operable to cause the sensor set 154 to record sensor data that describes one or more sensor measurements of the connected vehicle 110. The sensor data includes one or more of the following: location data describing a geographic location of the connected vehicle 110; and heading data describing a heading of the connected vehicle 110. The sensor data may further include one or more of the following: speed data describing a speed of the connected vehicle 110; acceleration data describing an acceleration pattern of the connected vehicle 110; and any other type of sensor data.

In some embodiments, the data collection module 204 generates vehicle data of the connected vehicle 110 based on the sensor data. For example, the vehicle data may include the sensor data. The vehicle data may further include one or more of the following: diagnostic information of the connected vehicle 110; and vehicle performance and efficiency information of the connected vehicle 110. The vehicle data may further include one or more of the following: information pertaining to black market parts placed on the connected vehicle 110; and information indicating whether the connected vehicle 110 has been reported stolen. Further, the vehicle data may include any other information related to the connected vehicle 110.

The determination module 206 can be software including routines for determining whether a threshold proximity is satisfied. In some embodiments, the determination module 206 can be stored in the memory 127 of the computer system 200 and can be accessible and executable by the processor 125. The determination module 206 may be adapted for cooperation and communication with the processor 125 and other components of the computer system 200 via a signal line 226.

In some embodiments, the determination module 206 determines whether a threshold proximity is satisfied. The threshold proximity describes a range between the connected vehicle 110 and the charging station 182 for charging the connected vehicle 110.

For example, the determination module 206 detects that the charging station 182 is in the vicinity of the connected vehicle 110 based on ranging sensor data detected by one or more ranging sensors of the connected vehicle 110. The determination module 206 determines whether a distance between the connected vehicle 110 and the charging station 182 is within the threshold proximity (e.g., whether the distance is within the range for charging the connected vehicle 110). Responsive to determining that the distance is within the threshold proximity, the determination module 206 determines that the threshold proximity is satisfied. Responsive to determining that the distance is not within the threshold proximity, the determination module 206 determines that the threshold proximity is not satisfied.

In another example, the determination module 206 determines whether a distance between the connected vehicle 110 and the charging station 182 is smaller than a distance threshold based on ranging sensor data detected by ranging sensors of the connected vehicle 110. Responsive to determining that the distance between the connected vehicle 110 and the charging station 182 is smaller than the distance threshold, the determination module 206 determines that the threshold proximity is satisfied. If the distance between the connected vehicle 110 and the charging station 182 is not smaller than the distance threshold, the determination module 206 determines that the threshold proximity is not satisfied. The distance threshold can be 0.2 m, 0.5 m, 1 m, 2 m, or any other appropriate distance value. In some examples, the distance threshold can be determined as a maximum distance between the connected vehicle 110 and the charging station 182 within which the connected vehicle 110 is capable of transmitting data to the charging station 182. In some examples, the distance threshold can be determined as a maximum distance between the connected vehicle 110 and the charging station 182 within which the connected vehicle 110 can be charged by the charging station 182.

In some embodiments, the threshold proximity is satisfied when the connected vehicle 110 passes by the charging station 182. In some other embodiments, the threshold proximity is satisfied when the connected vehicle 110 is parked at the charging station 182.

Responsive to a determination that the threshold proximity is satisfied, the determination module 206 wirelessly transmits the vehicle data of the connected vehicle 110 to the charging station 182 via the communication unit 145. On the other hand, responsive to a determination that the threshold proximity is not satisfied, the vehicle data of the connected vehicle 110 may not be transmitted to the charging station 182.

In some embodiments, the determination module 206 may execute an authentication process with the charging station 182 before transmitting the vehicle data to the charging station 182 to prevent an unauthorized data transfer. In some embodiments, the determination module 206 may also encrypt the vehicle data before transmission so that data security can be achieved.

From the above description for FIG. 2, the data uploading system 199 uses wireless communications to automatically transfer vehicle data from the connected vehicle 110 to the charging station 182 based on a proximity of the vehicle 110 to the charging station 182. The charging station 182 is operable to relay the vehicle data to a centralized location. For example, the data uploading system 199 automatically transfers the vehicle data from the connected vehicle 110 to a centralized location via the charging station 182 when the vehicle 110 comes within a threshold proximity of the charging station 182.

The vehicle data is analyzable to determine whether the connected vehicle 110 has had a black-market part installed therein. For example, the charging station 182 (e.g., the edge server 180 at the charging station 182) may be operable to determine whether the connected vehicle 110 has had black market parts installed therein based on the vehicle data. In another example, the edge server 180 may relay the vehicle data to the cloud server 160 (or the centralized computing device 140) which may be operable to determine whether the connected vehicle 110 has had black market parts installed therein based on the vehicle data.

### Example Processes

Referring now to FIG. 3, depicted is a flowchart of an example method 300 for uploading vehicle data at the charging station 182 according to some embodiments. The steps of the method 300 are executable in any order, and not necessarily the order depicted in FIG. 3.

At step 301, the determination module 206 determines that a threshold proximity is satisfied, where the threshold proximity describes a range between the connected vehicle 110 and the charging station 182 for charging the connected vehicle 110.

At step 303, the determination module 206 wirelessly transmits vehicle data to the charging station 182, where the wireless transmission of the vehicle data occurs responsive to the determination that the threshold proximity is satisfied. In some embodiments, the wireless transmission is unicast. In some other embodiments, the wireless transmission is broadcast.

Prior to step 301, the method 300 may further include collecting, by the data collection module 204, the vehicle data of the connected vehicle 110.

In some embodiments, the charging station 182 is operable to relay the vehicle data to a centralized location. The vehicle data is analyzable to determine whether a black-market part is installed in the connected vehicle 110. For example, the vehicle data describes one or more of the following: diagnostic information about the connected vehicle 110; performance information about the connected vehicle 110; and efficiency information about the connected vehicle 110.

In some embodiments, the connected vehicle 110 is an autonomous vehicle.

In some embodiments, the charging station 182 includes an edge server.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present embodiments can be described above primarily with reference to user interfaces and particular hardware. However, the present embodiments can apply to any type of computer system that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present embodiments of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some preferred embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited, to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A computer program product comprising a non-transitory memory of an onboard vehicle computer system of a connected vehicle storing computer-executable code that, when executed by a processor, causes the processor to:
collect vehicle data associated with the connected vehicle;
determine that a threshold proximity is satisfied, wherein the threshold proximity describes a range between the connected vehicle and a charging station for charging the connected vehicle; and
wirelessly transmit the vehicle data to the charging station, wherein the wireless transmission of the vehicle data occurs responsive to the determination that the threshold proximity is satisfied.

2. The computer program product of claim 1, wherein the charging station is operable to relay the vehicle data to a centralized location.

3. The computer program product of claim 1, wherein the vehicle data is analyzable to determine whether a black-market part is installed in the connected vehicle.

4. The computer program product of claim 1, wherein the vehicle data describes one or more of the following: diagnostic information about the connected vehicle; performance information about the connected vehicle; and efficiency information about the connected vehicle.

5. A method comprising:
determining that a threshold proximity is satisfied, wherein the threshold proximity describes a range between a connected vehicle and a charging station for charging the connected vehicle; and
wirelessly transmitting vehicle data to the charging station, wherein the wireless transmission of the vehicle data occurs responsive to the determination that the threshold proximity is satisfied.

6. The method of claim 5, wherein the charging station is operable to relay the vehicle data to a centralized location.

7. The method of claim 5, wherein the vehicle data is analyzable to determine whether a black-market part is installed in the connected vehicle.

8. The method of claim 5, wherein the vehicle data describes one or more of the following: diagnostic information about the connected vehicle; performance information about the connected vehicle; and efficiency information about the connected vehicle.

9. The method of claim 5, wherein the connected vehicle is an autonomous vehicle.

10. The method of claim 5, wherein the wireless transmission is unicast.

11. The method of claim 5, wherein the wireless transmission is broadcast.

12. The method of claim 5, wherein the charging station includes an edge server.

13. A system comprising:
a computer system including a non-transitory memory storing computer code which, when executed by the computer system, causes the computer system to:
determine that a threshold proximity is satisfied, wherein the threshold proximity describes a range between a connected vehicle and a charging station for charging the connected vehicle; and
wirelessly transmit vehicle data to the charging station, wherein the wireless transmission of the vehicle data occurs responsive to the determination that the threshold proximity is satisfied.

14. The system of claim 13, wherein the charging station is operable to relay the vehicle data to a centralized location.

15. The system of claim 13, wherein the vehicle data is analyzable to determine whether a black-market part is installed in the connected vehicle.

16. The system of claim 13, wherein the vehicle data describes one or more of the following: diagnostic information about the connected vehicle; performance information about the connected vehicle; and efficiency information about the connected vehicle.

17. The system of claim 13, wherein the connected vehicle is an autonomous vehicle.

18. The system of claim 13, wherein the wireless transmission is unicast.

19. The system of claim 13, wherein the wireless transmission is broadcast.

20. The system of claim 13, wherein the charging station includes an edge server.
